(19) United States
(12) Patent Application Publication
(10) Pub. No.: US 2017/0243479 A1
(43) Pub. Date: Aug. 24, 2017

(54) COMMUNITY SECURITY SYSTEM

(71) Applicant: REACH Consulting Group, LLC, Lithonia, GA (US)

(72) Inventor: Robford Elton Hill, Lithonia, GA (US)

(21) Appl. No.: 15/436,416

(22) Filed: Feb. 17, 2017

Related U.S. Application Data
(60) Provisional application No. 62/297,613, filed on Feb. 19, 2016.

(51) Int. Cl. G08G 1/054; G06F 17/30; G06K 9/78; G06K 9/00; H04N 7/18

(52) U.S. Cl. CPC G08G 1/054; G06K 9/00785; H04N 7/18; G06K 9/00771; G06K 9/00711; G06K 9/78; G06F 17/30241; G06F 17/30268; G06F 17/30256; G06F 17/3028

(57) ABSTRACT

Disclosed are system and processes that provide for community security systems. These community security systems integrate technology, community resources, and people to deter, prevent, or minimize the impact of intrusion, invasion, or unlawful entry to the community. An integrated management security system, an alert tower system, and a detection device system can communicate in real time to provide alerts regarding the presence of unauthorized, dangerous, reckless, or otherwise undesired vehicles or activities to members of an associated community.

### CLAIM OF PRIORITY UNDER 35 U.S.C. §119

This Non-Provisional patent application claims priority to Provisional Application No. 62/297,613 titled “Community Security System” filed Feb. 19, 2016, filed by the same inventor and applicant, and hereby expressly incorporated by reference herein.

### FIELD OF THE INVENTION

This disclosure generally relates to community security devices and systems.

### BACKGROUND

Many communities with a network of roads, such as neighborhoods and universities, have a difficult time monitoring their roads and buildings for dangerous, nefarious, or otherwise undesired vehicles and actions. Current security systems provide general security cameras that record actions, but do not take any active steps to address potential issues as they arrive in real time. Therefore, a need exists to integrate detection devices, alert towers, and members of a community into an integrated management security system to provide alerts for detected undesired activity in real time.

### SUMMARY OF INVENTION

The following presents a summary of certain embodiments of the present invention. This summary is not intended to be a comprehensive overview of all contemplated embodiments, and is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for providing community security. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

For sample, illustrative purposes, system environments will be summarized. The system may involve one or more security devices, one or more memory devices having computer readable program code stored thereon, a communication device, and one or more processing devices operatively coupled to the one or more memory devices, wherein the one or more processing devices are configured to execute the computer readable program code to perform certain functions. As such, in some embodiments, the system monitors the one or more security devices for a triggering characteristic and receives the triggering characteristic from at least one of the one or more security devices. The system may then, in response to receiving the triggering characteristic, provide an alert to one or more members of a community or to one or more security responders.

Some embodiments of the system further comprise the one or more security devices comprise vehicle monitors positioned in a geographical area, and wherein the vehicle monitors are configured to record vehicle data in real time and store the vehicle data in a database. In some such embodiments, the system may also receive new vehicle data from one of the vehicle monitors, wherein the new vehicle data comprises vehicle data associated with a new vehicle in the geographical area to determine that the received new vehicle data meets the triggering characteristic. Next, in some embodiments, the system may provide the alert to the one or more members of the community or to the one or more security responders based on determining that the received new vehicle data meets the triggering characteristic, wherein the one or more members of the community are associated with the geographical area.

In some embodiments of the system, the one or more security devices comprising the vehicle monitors, wherein the vehicle monitors include one or more cameras configured to record, in real time, an image or video of vehicles as the vehicles pass by. Additionally, the system may receive registered vehicle information from the one or more members of the community and store the registered vehicle information in a registered vehicle database. Next, the system may receive the new vehicle data, wherein the new vehicle data includes a new image or video of the new vehicle received from the one or more cameras. The system may analyze the new image or video to identify new vehicle information and compare the identified new vehicle information to the stored registered vehicle information. Finally, the system can either take no action in response to determining that the new vehicle information matches at least a portion of registered vehicle information, or provide the alert to the one or more members of the community or to the security responders in response to determining that the new vehicle information does not match any of the registered vehicle information.

Some embodiments of the system comprise the one or more security devices comprising the vehicle monitors, wherein the vehicle monitors include vehicle speed detection devices. In some such embodiments, the system may receive the new vehicle data, wherein the new vehicle data comprises a detected speed of the new vehicle at one or more of the speed detection devices, compare the detected speed of the new vehicle to a predetermined speed threshold associated with the geographical location and determine, based on the comparison of the detected speed to the predetermined speed threshold, that the detected speed of the new vehicle exceeds the predetermined speed threshold. In some embodiments, the system may, in response to determining that the detected speed of the new vehicle exceeds the predetermined speed threshold, provide the alert to the one or more members of the community or to the one or more security responders.

The system may additionally or alternatively comprise the one or more security devices comprising the vehicle monitors, wherein the vehicle monitors include at least a mobile computing device detector. In some such embodiments, the system may receive the new vehicle data, wherein the new vehicle data comprises a number of mobile computing devices associated with the new vehicle detected by the mobile computing device detector, and in response to determining that the received new vehicle data meets the triggering characteristic, provide the alert to the one or more members of the community or to the security responders, wherein the alert includes at least the number of mobile devices associated with the new vehicle.

Some embodiments of the system include one or more alert towers positioned in the geographical area. In some such embodiments, the system may command at least one of the one or more alert towers to provide the alert to the one or more members of the community based on determining that the received new vehicle data meets the triggering characteristic. Additionally, the system may of commanding the at least one of the one or more alert towers to provide the alert may further comprise causing one or more speakers of the one or more alert towers to emit an audible alarm.

Finally, in some embodiments, the system comprises one or more alert towers positioned in a geographical area, wherein the one or more alert towers comprise an audio detecting device and an alert transmitter. In some such embodiments, the system may receive the triggering characteristic from the at least one or more security devices by detecting, via the audio detecting device of the one or more alert towers, an audible alarm and, in response to detecting the audible alarm, provide the alert to the one or more members of the community via the alert transmitter of the one or more alert towers.

To the accomplishment of the foregoing and related objectives, the embodiments of the present invention comprise the function and features hereinafter described. The following description and the referenced figures set forth a detailed description of the present invention, including certain illustrative examples of the one or more embodiments. The functions and features described herein are indicative, however, of but a few of the various ways in which the principles of the present invention may be implemented and used and, thus, this description is intended to include all such embodiments and their equivalents.

The features, functions, and advantages that have been discussed may be achieved independently in various embodiments of the invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram illustrating a community security system environment, in accordance with an embodiment of the invention;

FIG. 2 is a flowchart illustrating a method for providing a community security system, in accordance with an embodiment of the invention;

FIG. 3 is a flowchart illustrating a method for providing a registered vehicle management community security system, in accordance with embodiments of the present invention;

FIG. 4 is a flowchart illustrating a method for providing a speed enforcement community security system, in accordance with an embodiment of the invention;

FIG. 5 is a flowchart illustrating a method for providing a mobile device recognition community security system, in accordance with an embodiment of the invention;

FIG. 6 is a flowchart illustrating a method for providing an alert tower community security system, in accordance with embodiments of the present invention;

FIG. 7 is flowchart illustrating a method for providing an alert tower community security system, in accordance with embodiments of the present invention;

FIG. 8 is a flowchart illustrating a method for receiving and communicating community alerts, in accordance with embodiments of the present invention; and

FIG. 9 is a flowchart illustrating a method for providing a community security messaging system to multiple members of a community, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

Various embodiments or features will be presented in terms of systems that may include a number of devices, components, modules, and the like. It is to be understood and appreciated that the various systems may include additional devices, components, modules, and the like, and/or may not include all of the devices, components, modules, and the like, discussed in connection with the figures. A combination of these approaches may also be used.

As used herein, the term “community” refers to any group of people that reside, work, vacation, or otherwise reside with some expectation of privacy from other members of the general public. For example, a community may be a residential neighborhood, a gated residential neighborhood, an office complex, a parking lot, a vacation home neighborhood, a hotel or resort, and the like.

A “community” is generally associated with a “geographical area” that defines the boundaries to which the community has an expectation of privacy and/or exclusion. The geographical area may be defined as a gated region around the community, the land on which the roads and/or houses associated with the community are located, a distance from a community center, a distance to which an alert tower of a community security system can provide alerts, and the like.

Thus, system and processes are described herein that provide for community security systems. These community security systems integrate technology, community resources, and people to deter, prevent, or minimize the impact of intrusion, invasion, or unlawful entry to the community. An integrated management security system, an alert tower system, and a detection device system can communicate in real time to provide alerts regarding the presence of unauthorized, dangerous, reckless, or otherwise undesired vehicles or activities to members of an associated community.

The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

For sample, illustrative purposes, system environments will be summarized. A first sample embodiment system may involve providing one or more vehicle monitors in a geographical area, wherein the vehicle monitors record vehicle data in real time and store the vehicle data in a database. The first system may also receive new vehicle data from one of the one or more vehicle monitors and determine that the received new vehicle data meets a triggering characteristic. Finally, the first system may provide an alert to at least a portion of a community associated with the geographical area based on determining that the received new vehicle data meets the triggering characteristic.

A second system example embodiment of the invention may involve receive registered vehicle information from a plurality of members of a community associated with a geographical area, and storing the registered vehicle information in a registered vehicle database. In some embodiments, the second system also comprises providing one or more cameras in the geographical area, wherein the one or more cameras are configured to record, in real time, an image of vehicles as the vehicles pass by. The second system may then receive a new image of a new vehicle from one of the one or more cameras, analyze the new image to identify new vehicle information, and compare the identified new vehicle information to the stored registered vehicle information. In some embodiments, the second system may determine that new vehicle information matches at least a portion of registered vehicle information associated with one of the plurality of members of the community. In other embodiments, the second system determines that the new vehicle information does not match any of the registered vehicle information, and provides an alert to at least a portion of the plurality of members of the community.

In a third system example embodiment of the invention, a system may provide one or more speed detection devices within a geographical area. This third system may then detect a speed of a vehicle at one or more of the speed detection devices and determine that the speed of the vehicle exceeds a predetermined threshold speed. Additionally, the third system may provide an alert to a community associated with the geographical area.

In a fourth system example embodiment of the invention, a system may provide one or more vehicle monitors in a geographical area, wherein the vehicle monitors record vehicle data in real time and store the vehicle data in a database, and wherein the one or more vehicle monitors includes at least a mobile computing device detector. Additionally, the fourth system may receive new vehicle data from one of the one or more vehicle monitors associated with a new vehicle in the geographical area, wherein the new vehicle data comprises a number of mobile computing devices associated with the new vehicle detected by the mobile computing device detector. Furthermore, the fourth system may determine that the received new vehicle data meets a triggering characteristic, and then provide an alert to a law enforcement agency or at least a portion of a community associated with the geographical area based on determining that the alert meets the triggering characteristic, wherein the alert includes at least the number of mobile devices detected by the mobile computing device detector.

In a fifth system example embodiment of the invention, a system may provide one or more vehicle monitors in a geographical area, wherein the vehicle monitors record vehicle data in real time and store the vehicle data in a database. This fifth system may also provide one or more alert towers in the geographical area. Additionally, the fifth system may receive new vehicle data from one of the one or more vehicle monitors and determine that the received new vehicle data meets a triggering characteristic. Finally, the fifth system may also command at least one of the one or more alert towers to provide an alert to at least a portion of a community associated with the geographical area based on determining that the alert meets the triggering characteristic.

In a sixth system example embodiment of the invention, a system may provide an alert tower comprising a sound recording device and an alert transmitter. This sixth system may then detect, at the alert tower, an audible alarm, and transmit an alert, via the alert transmitter, to the geographical area in response to detecting the audible alarm.

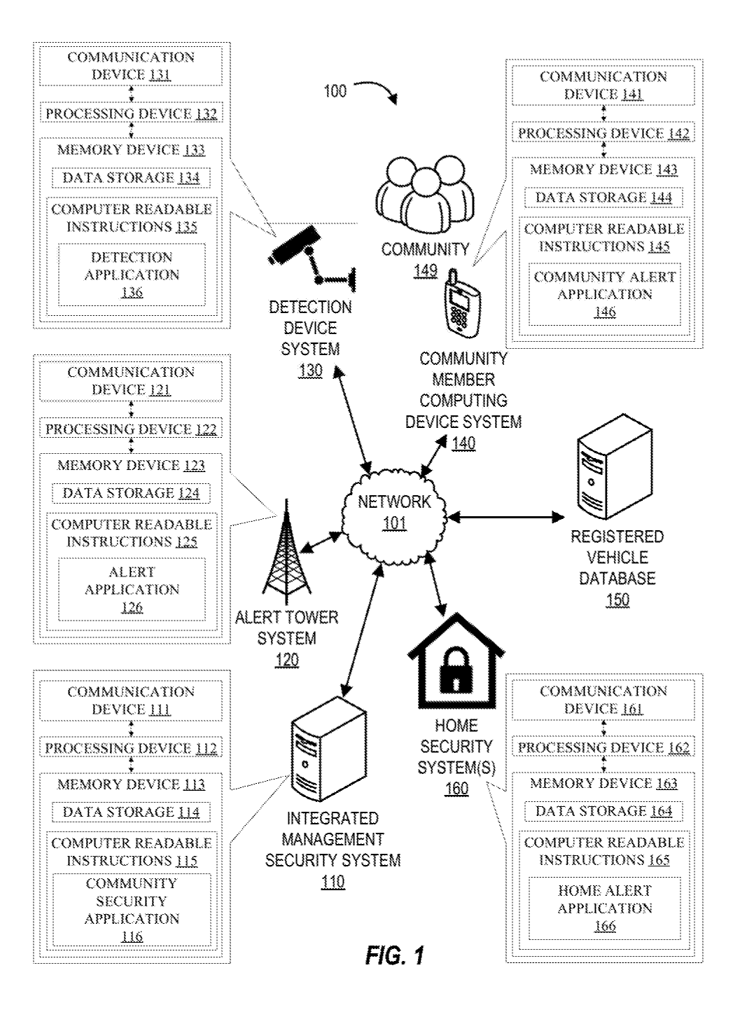

FIG. 1 illustrates an embodiment of a system 100 for providing a community security system. As illustrated, the system 100 may include a network 101 electronically connected to an integrated management security system 110, an alert tower system 120, a detection device system 130, a community member computing device system 140, a registered vehicle database 150, and a home security system 160. The community member computing device system 140 shows a single computing device, but may actually be multiple computing devices, where each computing device is associated with one or more members of a community 149. The alert tower system 120 may comprise a single tower or multiple towers. As used herein, the term “tower” shall represent a station within a geographical area of a community that can receive information (e.g. sound, electronic messages, and the like), and transmit an alert to at least a portion of the community 149. The detection device system 130 may comprise a single detection device or multiple detection devices. In embodiments with multiple detection devices, each device may be located at a different position within the geographical area of a community 149, and multiple detection devices that detect different attributes may be located at substantially the same location or be combined into a single detection device with multiple detection attributes. The integrated management security system 110, the alert tower system 120, the detection device system 130, the community member computing device 140, the registered vehicle database 150, and the home security system(s) 160 may be in electronic communication with each other and/or the network 110. As illustrated, the integrated management security system, the alert tower system 120, the detection device system 130, and the community member computing device system 140 each include a communication device 111, 121, 131, 141, and 161; a processing device 112, 122, 132, 142, and 162; a memory device 113, 123, 133, 143, and 163; a data storage 114, 124, 134, 144, and 164; and computer readable instructions 115, 125, 135, 145, and 165.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise. In this regard, the term “processor” and “processing device” are terms that are intended to be used interchangeably herein and features and functionality assigned to a processor or processing device of one embodiment are intended to be applicable to or utilized with all or a portion of any other embodiment, unless stated otherwise. As used herein, a “communication device” 111, 121, 131, 141, and 161 may generally include a modem, server, transceiver, and/or other device for communicating with other devices on a network. A “processing device” 112, 122, 132, 142, and 162 may generally refer to a device or combination of devices having circuitry used for implementing the communication and/or logic functions of a particular system. For example, a processing device 112, 122, 132, 142, and 162 may include a digital signal processor device, a microprocessor device, and various analog-to-digital converters, digital-to-analog converters, and other support circuits and/or combinations of the foregoing. Control and signal processing functions of the system may be allocated between these processing devices according to their respective capabilities. The processing device may further include functionality to operate one or more programs based on computer-executable program code thereof, which may be stored in a memory device 113, 123, 133, 143, and 163. As the phrase is used herein, a processing device may be “configured to” perform a certain function in a variety of ways, including, for example, particular computer-executable program code embodied in computer-readable medium, and/or by having one or more application-specific circuits perform the function. The processing device 112, 122, 132, 142, and 162 may be configured to use the communication device 111, 121, 131, 141, and 161 to transmit and/or receive data and/or commands to and/or from other devices within the network 101.

A “memory device” 113, 123, 133, 143, and 163 may generally refer to a device or combination of devices that store one or more forms of computer-readable media for storing data and/or computer-executable program code/instructions. For example, in one embodiment, the memory device 113, 123, 133, 143, and 163 may include any computer memory that provides an actual or virtual space to temporarily or permanently store data and/or commands provided to the processing device 112, 122, 132, 142, and 162 when it carries out its functions described herein.

In one embodiment, the memory device 113 of the integrated management security system 110 includes computer readable instructions 115 that include a community security application 116, discussed more fully below. Additionally, the memory device 123 of the alert tower system 120 includes computer readable instructions 125 that include an alert application 126, as discussed more fully below. Furthermore, the memory device 133 of the detection device system 130 includes computer readable instructions 135 that include a detection application 136, as discussed more fully below. Similarly, the memory device 143 of the community member computing device system 140 includes computer readable instructions 145 that include a community alert application 146, as discussed more fully below. Finally, the memory device 163 of the home security system 160 includes computer readable instructions 165 that include a community alert application 166, as discussed more fully below.

Additionally, in some embodiments, the memory devices 113, 123, 133, 143, and 163 include data storage 114, 124, 134, 144, and 164, or databases configured for storing information and/or data. In other embodiments, the data storages 114, 124, 134, 144, and 164, may be housed remotely from the integrated management security system 110, the alert tower system 120, the detection device system 130, the community member computing device system 140, and/or the home security system(s) 160. In such embodiments, each data storage 114, 124, 134, 144, and 164 is in communication with its respective system 110, 120, 130, 140, and 160 across the network 101 and/or across some other communication link.

The network 101 may include a local area network (LAN), a wide area network (WAN), and/or a global area network (GAN). The network 101 may provide for wireline, wireless, or a combination of wireline and wireless communication between devices in the network. In some embodiments, the network 101 includes a wireless telephone network. In some embodiments, the network includes the Internet. In some embodiments, the network 101 includes an intranet. Furthermore, the network 101 may include a combination of an intranet and the Internet.

The community security application 116 may be any type of application capable of managing the alert tower system 120, the detection device system 130, the community member computing device system 140, the registered vehicle database 150, and/or the home security system(s) 160 to provide a community security system for the community 149. In some embodiments, the community security application 116 is located within, and operates in conjunction with, the alert tower system 120, the detection device system 130, and/or the community member computing device system 140.

The alert application 126 of the alert tower system 120 may be any type of application capable of receiving warning or alert information from the network 101, and transmitting an alert to the community 149, either electronically through the network 101, audibly through a speaker, visually through a light alarm, and/or the like. In some embodiments, a physical or touch-screen emergency button at an alert tower of the alert tower system 120. This emergency button may be depressed or selected by a member of the community to indicate that that member needs emergency assistance from other members of the community, a security officer, a police officer, or the like. The alert application 126 may transmit a predefined emergency message to one or more of these potential responders. Additionally, the alert application 126 may cause one or more alert towers in the alert tower system 120 to transmit a visual (e.g., bright lights, flashing lights, flood lights, etc.), audible (e.g., siren alarm, spoken word alarm, etc.), or electronic (e.g., text message, email, pop-up notification) warning to at least a portion of the members of the community 149.

The detection application 136 of the detection device system 130 may be any type of application capable of detecting the presence of an object, a signal, and any other item entering the geographical area of the community 149. The detection application may be part of a physical detector associated with the detection device system 130, such as a camera, an infrared camera, a motion sensor, a radar signal detector, a MAC address detector, a digital signature detector, a pressure hose, and the like. The detection application 136 may cause the detector to detect an object and record the detection for use by the remaining portions of the system 100 to provide a community security system for the community 149.

The community alert application 146 may be any application capable of receiving and/or transmitting alerts to or from members of the community 149, the alert tower system 120, and/or the integrated management security system 110. In some embodiments, the integrated management security system 110 and/or the alert tower system 120 may establish an electronic communication channel with a community member computing device of the community member device system 140 to cause the computing device to display, on a user interface of the computing device, a warning or alert based on a detection by the detection device system 130 and/or the alert tower system 120. Additionally, or alternatively, the community alert application 146 may display a selectable alert icon on the user interface of a computing device associated with the community member computing device 140, such that when a member of the community 149 selects the alert icon, an electronic signal is sent from the community member computing device system, through the network 101, to the alert tower system 120 and/or the integrated management security system 110.

The registered vehicle database 150 may be any data storage space stored separately from, or integrated within the integrated management security system 110, the alert tower system 120, the detection device system 130, and/or the community member computing device system 140. The registered vehicle database 150 may be any data storage device that records vehicle data (e.g., information), that is input by members of the community 149 and/or the detection device system 130. In some embodiments, the data storage device can be accessed by the integrated management security system 110, the alert tower system 120, the detection device system 130, and/or the community member computing device system 140, such that the stored data of the registered vehicle database can be read, compared, extracted, and the like. In some embodiments, the registered vehicle database 150 stores data associated with vehicles that belong to members of the community 149, or are otherwise common to, allowed to, or expected to enter the geographical area of the community 149. For example, the registered vehicle database 150 may store information about the make and model of vehicles, the estimated size of vehicles, license plate information for vehicles, tire information for vehicles, color information for vehicles, home locations for vehicles, expected roads of travel for vehicles, permitted service-related vehicles, and the like. The registered vehicle database 150 may also store time information related to each registered vehicle. For example, certain service-related vehicles like contractors may be registered to be in the geographical area of the community 149 only during normal working hours, so the registered vehicle database 150 may store such information in combination with other vehicle information for a registered contractor's vehicle.

The home security system 160 may be any security system configured to prevent, detect, and warn against security issues and vulnerabilities of a house, an office, a building, a car, and the like. In some embodiments, a single home security system 160 is associated with a single member of the community 149, a group of members of the community 149, the integrated management security system 110, and the like.

The home alert application 166 may be any application capable of receiving and/or transmitting alerts to or from members of the community 149, the alert tower system 120, and/or the integrated management security system 110. In some embodiments, the home security system includes a speaker, display, or other user interface configured to transmit an audible and/or visual alert to individuals within an associated home. In some embodiments, the integrated management security system 110 and/or the alert tower system 120 may establish an electronic communication channel with a community member computing device of the home security system 160 to cause the speakers or other user interfaces to display the warning or alert based on a detection by the detection device system 130 and/or the alert tower system 120.

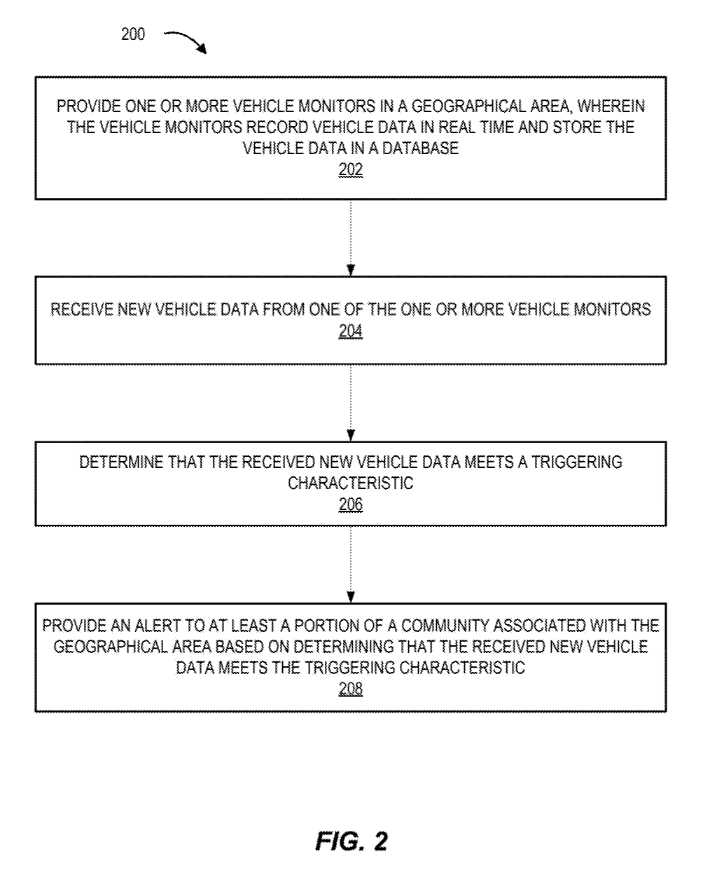

Referring now to FIG. 2, a flow chart is provided, illustrating a general community security system process 200, in accordance with an embodiment of the invention. The process 200 may include block 202, where the system provides one or more vehicle monitors in a geographical area. These vehicle monitors may be cameras, speed detectors, pressure hoses, and the like. The vehicle monitors may be designed and/or positioned to be highly visible, providing a deterrence function in addition to their normal function of monitoring vehicles in the geographical area.

Examples of what the vehicle monitors detect include, but are not limited to, license plate numbers of a vehicle, the estimated size of a vehicle, an estimated weight of a vehicle, a sound of a vehicle, images of occupants of a vehicle, color of a vehicle, the make and model of a vehicle, the speed of a vehicle, the direction of a vehicle, identifying characteristics of a vehicle (company names on the vehicle), the time that a vehicle was detected, and the like.

In some embodiments, two or more vehicle monitors may be positioned at different locations within the geographical area. In such embodiments, each vehicle monitor may detect the presence of, and record information about, a vehicle as it passes by the road or driveway of each vehicle detector. The information from each of the two or more vehicle detectors may be compared and analyzed to determine time-based, speed-based, and other characteristics of the vehicle's presence in the geographical area of the community. For example, a first vehicle detector may take an image of a vehicle and record the license plate number of the vehicle and the exact time at which the image was taken. A second vehicle detector may also record an image of the same vehicle, recording the matching license plate number and time-stamp this second image with a second time. The system may then compare the times and a known distance between the two vehicle detectors to determine speed information of the vehicle or a total time in which the vehicle was present within the geographical area of the community.

The process 200 may also include block 204, where the system receives new vehicle data from one or more of the one or more vehicle monitors. As described above, the vehicle data may be any descriptive information about the vehicle and/or its presence or interaction with the geographical area of the community. The term “new vehicle” refers to the presence of any vehicle (registered or not) that is presently being detected by a vehicle monitor. The vehicle monitor will record information about the vehicle as vehicle data in real time, and can store the vehicle data in a database for instant access by the community security system. The system may access this vehicle data in real time, or substantially real time, for analyzing purposes such that any necessary actions in response to a detection can be conducted while the vehicle is still present in the geographical area.

For example, the system may set up vehicle monitors in the forms of cameras at every entrance and exit of a defined geographical area (e.g., a community, a neighborhood, a campus, etc.), such that the system can record a license plate number for every vehicle that enters or exits the defined geographic area. The vehicle monitors may also include time stamp data to record entering times and exiting times for each vehicle. Furthermore, the system can maintain a record of vehicle license plate numbers that are currently present in the defined geographical area.

In some embodiments, the process 200 may include block 206, where the system determines that the received new vehicle data meets a triggering characteristic. The system may have a database of stored triggering characteristics, which can be accessed and compared against the received new vehicle data to determine if a triggering event has occurred. As used herein, the term “triggering characteristics” refers to a characteristic of the new vehicle, as recorded by a vehicle monitor, which causes a triggering event to occur. A “triggering event” may include, but is not limited to the following events or occurrences: the new vehicle does not match any characteristics of registered vehicles, the recorded speed of the new vehicle is above a certain threshold, the new vehicle has been located within the geographical area of the community for longer than a predetermined time, the new vehicle data matches data associated with unwelcome or unauthorized vehicles for the geographical area of the community, and the like.

The system may analyze the received new vehicle data by comparing the received vehicle data to registered vehicle data (information about vehicles that are authorized to enter the community), threshold speeds, threshold vehicle presence time periods, unauthorized vehicle data, authorized time of day data, and the like to determine whether the received new vehicle data matches, fails to match, or otherwise meets a triggering characteristic.

Finally, in some embodiments, the process 200 includes block 208, where the system provides an alert to at least a portion of a community associated with the geographical area based on the determination that the received new vehicle data meets the triggering characteristic. Since the system has determined that the received new vehicle data meets a triggering characteristic, the system may be configured to warn members of the community about the triggering event. In some embodiments, the members of the community are immediately alerted to the triggering event in real time, or substantially real time, as the system determines that the triggering characteristic is met. In other embodiments, the system may store at least a portion of the new vehicle data for future reference, in the event that one or more members of the community wishes to check or report the new vehicle data to a law enforcement officer, a reporting agency, other members of the community, or the like. In some embodiments, the system automatically notifies a law enforcement agency of the occurrence of the triggering event (as indicated by the triggering characteristic), such that the law enforcement agency may quickly respond to any potential threat that the new vehicle poses to the community.

When alerting members of the community, the system has several options. For example, the system may send a command to an alert tower located within the geographical area of the community, instructing the alert tower to transmit an audible, visual, or electronic message alarm to the community. In some cases, the system may command the alert tower to transmit an audible siren or pre-recorded spoken warning that can be heard by at least a portion of the members of the community that live or work near the alert tower. Additionally or alternatively, the system may transmit an alert to the members of the community by sending an electronic message, such as an email, text message, pop-up message, and the like, to each member of the community, describing the triggered event, a time of the triggered event, and any additional information such as protective, safety measures or protocols for the members of the community to follow.

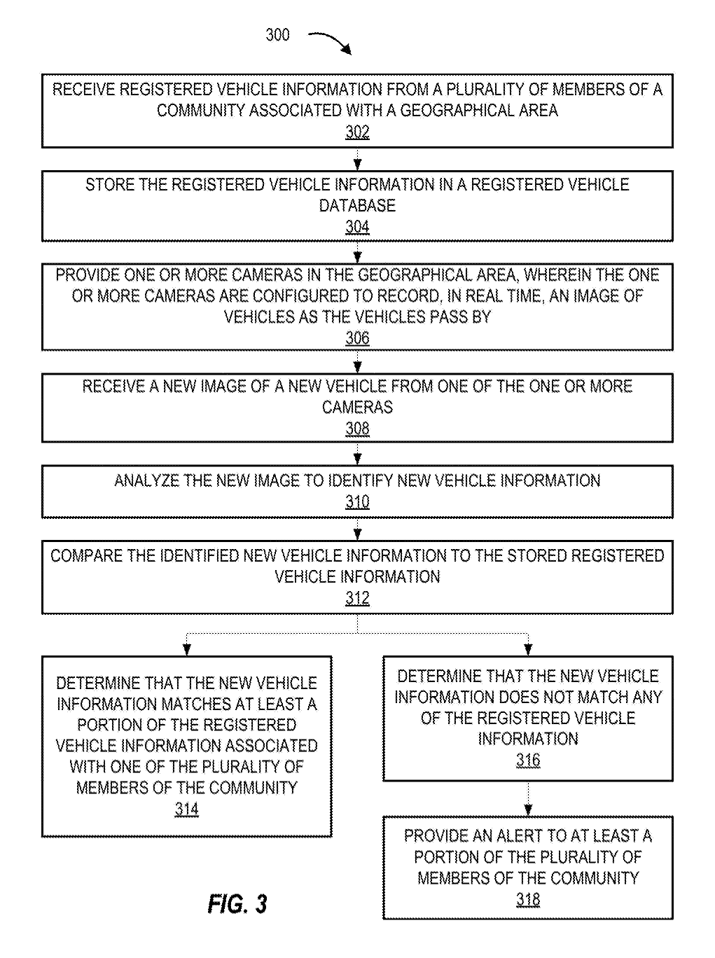

FIG. 3 illustrates a process 300 for providing a registered vehicle management community security system, in accordance with embodiments of the present invention. This system operates in real time to record vehicle data with one or more cameras, and analyzes this data in real time to determine whether an alert should be propagated to one or members of a community. The real time aspect of this process 300 allows for members of the community, security personnel, and/or police personnel to prepare and respond to any potential threats in a timely manner. Normal security cameras may record vehicle information, but they do not provide a real time analysis of the recorded images or video such that any potential threats can be handled in a timely manner. The process 300 described herein allows a community to actively protect itself from the presence of unwanted or unauthorized vehicles, and may be designed to grow databases of registered and/or non-registered vehicles associated with the community.

The process 300 may include block 302, where the system receives registered vehicle information from a plurality of members of a community associated with a geographical area. As described above, the registered vehicle information may comprise any identification-based characteristics of vehicles owned or operated by members of the community, or of vehicles that are otherwise expected to be present in the geographical area of the community.

These characteristics may include, but are not limited to, license plate numbers of a vehicle, the estimated size of a vehicle, an estimated weight of a vehicle, a sound of a vehicle, color of a vehicle, the make and model of a vehicle, and other identifying characteristics of a vehicle, such as company names on the vehicle. The system may receive the registered vehicle information from the members of the community, or an organizing member of the community that can input the relevant information into the system.

In some embodiments, the system may determine how often one or more vehicles are detected by a vehicle monitor of the system. In such embodiments, once an unregistered vehicle has been present a certain number of times (or has been present a certain number of times within a predetermined period of time, e.g., ten times in one month), then the system may determine that this unregistered vehicle can now be registered as authorized, or otherwise expected to be present in the geographical area of the community, at least during certain times of the day. In this way, a system may determine that vehicles associated with a common service provider such as a contractor, a cleaning crew, a pet walker, and the like, that were not already entered into the system as being registered, likely do not pose a threat to the community. Therefore, the system may register such vehicles such that these vehicles can be monitored in the same manner as other registered vehicles.

In some embodiments, the process 300 includes block 304, where the system stores the registered vehicle information in a registered vehicle database. The registered vehicle information may be stored in databases located at a vehicle monitor, an alert tower, in an integrated management security system, and/or in a registered vehicle database. The registered vehicle information may be stored such that other and applications of the community security system may access, edit, add, and/or remove the registered vehicle information in the database via a common network.

The process 300 may also include block 306, where the system provides one or more cameras in the geographical area, wherein the one or more cameras are configured to record, in real time, an image of vehicles as the vehicles pass by. In some embodiments, the cameras are community surveillance cameras that are associated with, or otherwise operated in conjunction with, other vehicle monitoring devices such as motion detectors, speed detectors (radar), weight detectors, sound detectors, and the like. Each of the one or more cameras may be set up at the same location or in different locations throughout the geographical area of the community. In some embodiments, multiple cameras are set up in substantially the same location of the geographical area of the community. For example, one camera may be set up relatively low to the ground and positioned in an expected direction of traffic such that a license plate of a vehicle is easily captured by the camera. A second camera may then be positioned facing the other expected direction of traffic, such that the second camera may capture a better image of the entire vehicle, possibly including images of occupants in the vehicle. In some embodiments, these two cameras may record images of a vehicle at the same time, or at different times.

The cameras may take a single image, multiple images of the vehicle, or a video of a vehicle as it passes by the camera. In some embodiments, the cameras are stationary and only record images in a certain direction. In other embodiments, a camera may be positioned on a motorized swivel, such that a single camera can take images or video at multiple different angles as a vehicle passes by.

These cameras may be designed and positioned within the geographical area of the community such that they are highly visible to drivers and/or passengers of vehicles as they enter, travel through, and/or leave a the geographical area of the community. By highlighting the presence of these security cameras, the system provides a deterrence warning to any drivers or passengers of vehicles that the community is prepared for any security threats and that the features of the vehicle may be recorded for law enforcement purposes. Of course, these cameras can be designed to be weather proof and vandalism proof, such that attempted tampering will not inhibit the camera from performing its task. The cameras may also have a testing component in which the system can periodically check to see if the camera is functioning correctly in real time and/or whether any adjustments in zoom, image quality, and the like should occur.

As described above, the system may set up vehicle monitors in the forms of cameras at every entrance and exit of the defined geographical area (e.g., a community, a neighborhood, a campus, etc.), such that the system can record a license plate number for every vehicle that enters or exits the defined geographic area. The device detectors may also include time stamp data to record entering times and exiting times for each vehicle. Furthermore, the system can maintain a record of vehicle license plate numbers that are currently present in the defined geographical area.

Furthermore, the process 300 may include block 308, where the system receives a new image of a new vehicle from one of the one or more cameras. As the cameras and other vehicle monitoring devices are in communication with other components of the community safety system via a network, the system can receive the images, or videos, recorded by the one or more cameras in real time, or substantially real time. In some embodiments, the system actively accesses the cameras, or databases associated with the cameras, to extract the image data. In other embodiments, the system may passively wait for an indication or transmission from a vehicle detection system associated with the cameras before receiving and/or storing the received new image of the new vehicle.

In some embodiments, the process 300 includes block 310, where the system analyzes the image to identify new vehicle information. The image may be analyzed in several different ways to extract the new vehicle information. In some embodiments, the system may use optical character recognition (OCR) or another text-extracting technology to lift letters, numbers, and symbols off of the image. This OCR process may be used to identify a license plate number of the new vehicle, a company name on the new vehicle, a make and/or model of the new vehicle, and any other text-based information that can be gleaned from an image of a vehicle. The text-based (or number-, or symbol-based) information can be compared with a template or other application in the system to match text-based words with vehicle information that is in the same format.

For example, the system may use OCR on an image of the new vehicle and determine that a sequence of a few numbers follows a sequence of a few letters. The system can match this format with the format for license plates in that state or a neighboring state to determine that the extracted text information from the image likely is the license plate of the vehicle. Additionally, the system may analyze the new image with a template of where certain expected information would be in vehicle images of the recording camera. For example, the system may have a stored template for camera number one that indicates that license plates are normally shown in the bottom left-hand quadrant of the images taken by camera one. Of course the system could be more or less exact in determining likely areas for certain text-based information.

Additionally, and/or alternatively, the system may analyze the new image or video of the new vehicle to determine a color, size, and the like of the new vehicle, and record this information as new vehicle information. As with the text-based information, the system may have a stored template for each camera that can indicate which regions of an image the color, size, and other characteristics of a vehicle are likely to be shown.

Ultimately, the system will analyze the image or video taken by one of the cameras and extract all the identifiable characteristics of the recorded vehicle, and will store these characteristics as the new vehicle information in a database.

The process 300 may also include block 312, where the system compares the identified new vehicle information to the stored registered vehicle information. The system may compare the identified new vehicle information against the stored vehicle information in an attempt to match the new vehicle information with the stored vehicle information. In some embodiments, the system provides for some lee-way in how exact the match must be. For example, if a license plate number of the new vehicle information is off by one digit or letter, the system may determine that the difference is likely due to a difficulty in recording or extracting text from a clear view of the license plate, but that the license plate likely is the same as the very close registered license plate. In another example, the system may determine that the color of a vehicle is slightly off what would be matched with another vehicle in the registered vehicle database, but that this difference could be due to dirt build-up on the new vehicle when it was imaged, so the extracted color information is close enough.

In some embodiments, a single piece of new vehicle information must match one or more pieces of registered vehicle information for the new vehicle to be considered a match with a registered vehicle. For example, if the system extracts a license plate number for the new vehicle, and the system matches this license plate number of the new vehicle with a recorded license plate number, then the system can safely assume that the new vehicle matches a registered vehicle.

In other embodiments, multiple pieces of new vehicle information must match multiple pieces of registered vehicle information. For example, the system likely cannot rely on the color of a new vehicle to determine that the new vehicle matches a registered vehicle since there are only a few common vehicle colors. Instead, the system may combine the vehicle color, the size of the vehicle, the make and/or model of the vehicle, and any other information, such as a weight of the vehicle (as determined by a weight detecting device at substantially the same location as the recording camera) to determine that the new vehicle matches a registered vehicle.

As described above, the system may set up vehicle monitors in the forms of cameras at every entrance and exit of the defined geographical area (e.g., a community, a neighborhood, a campus, etc.), such that the system can record a license plate number for every vehicle that enters or exits the defined geographic area. The device detectors may also include time stamp data to record entering times and exiting times for each vehicle. Furthermore, the system can maintain a record of vehicle license plate numbers that are currently present in the defined geographical area. Of course, other vehicle identifying information like the color, size, weight, make and model, etc., can be stored along with the license plate information in the record of vehicles currently present in the defined geographical area.

From block 312, the system may determine that the new vehicle information matches at least a portion of registered vehicle information associated with one of the plurality of members of the community, as shown in block 314. In such cases, no immediate action may need to occur, so the system may store the new vehicle information in a database, along with time stamps for when it was recorded. In other embodiments, the system may simply delete the new vehicle information to keep memory space available for future images of vehicles that are captured by the system.

Alternatively, in some embodiments, the process 300 may include block 316, where the system determines that the new vehicle information does not match any of the registered vehicle information. As described above, the system may match a single piece of new vehicle information with a single piece of registered vehicle information, but the system may determine that the match is not a strong enough link to assume that the new vehicle is the same as a registered vehicle. In such embodiments, the system would still determine that the new vehicle does not match a registered vehicle.

The steps taken in block 316 may be conducted in response to receiving a prompt, alert, or request regarding the status of vehicles currently present (or present at some point in time) in the defined geographic area. For example, if the system determines that a security compromising event has occurred within the geographic area, the system can automatically access or otherwise query the record of vehicles currently present. This record can be transmitted from the system or a central monitoring center of the system at least in the manner described below with respect to block 318.

Finally, the system may move from block 316 to block 318, where the system provides an alert to at least a portion of the plurality of members of the community. Because the system has determined that the new vehicle does not match a registered vehicle, the system may provide several different alerts to the community, ranging from storing the mismatch in a non-registered vehicle database, providing an electronic message to at least a portion of the members of the community, transmitting a visual alert from one or more alert towers stationed within the geographical area of the community, alerting security personnel associated with the community, alerting a police department associated with the community, transmitting an audible alert (e.g., a siren or spoken warning) from one or more alert towers, or any combination of the foregoing. This list is meant to be non-limiting, and any other alerts that can warn members of the community, or security/government personnel associated with the community, could be used as the alert.

In some embodiments, the system may store the new vehicle information together in a non-registered, or “unknown” database, along with other vehicle information for vehicles that do not match registered vehicles in the registered vehicle information database. This non-registered database may be analyzed periodically, or in real time as each set of new vehicle information is added to the database, such that the system may identify a pattern of presence for each non-registered vehicle.

This pattern could be used by the system to determine whether a non-registered vehicle likely has an approved or authorized reason to be in the geographical area of the community. For example, if the system identifies the same, or similar, non-registered new vehicle information periodically, during weekdays, at common business hours, then the system may determine that the set of vehicle information of the non-registered new vehicle should be included in the authorized database, at least for a certain period of time. The system could add this commonly returning vehicle to the database for a certain predefined period (e.g., a month), and add time-based authorization information for the commonly returning vehicle that is based on the common arrival and departure times.

For example, the system may authorize the commonly returning vehicle to be in the geographical area of the community from one hour before the commonly returning vehicle normally arrives until one hour after the commonly returning vehicle normally departs the geographical area of the community. The system may grant this authorization for a period of a month, or until the commonly returning vehicle does not register with a camera for a predetermined period of time (e.g., two weeks). In this way, the members of the community would not need to register a new vehicle or a vehicle of contractors, pet sitters, common delivering companies, cleaning personnel, family members, commonly visiting friends, and the like.

Additionally, this pattern could be used by the system to determine whether a non-registered vehicle is visiting the geographical area of the community for nefarious or otherwise unauthorized purposes. For example, if the system identifies the same, or similar, non-registered new vehicle information periodically during times that are not normal working hours, or common times for vehicle and/or house break-ins, then the system may tag the vehicle information of this commonly returning vehicle for a heightened level of alerts than other non-registered vehicles. Additionally, the system may add this vehicle information of the commonly returning vehicle to an unauthorized database with other vehicles that likely are not welcome in the geographical area.

In embodiments where the alert is a transmission of a report of the cars currently present within the geographic area (e.g., a community, a neighborhood, a campus, etc.), the system may transmit the report to one or more computing devices of community members, administrative members, police or other law enforcement entities, and the like. In this way, the system can, in response to detecting a security compromising event within the geographic area, provide a list of vehicles currently present in the geographic area to law enforcement officers, along with any additional information the vehicle monitoring devices are able to acquire.

Additionally, the system may compare and/or match the vehicle data in this report to one or more registered or otherwise known vehicles for the community associated with the geographic area. For example, the alert provided by the community security system may list all vehicles currently present (or at least recently present), a duration of time that the vehicles have been present in the community area, whether each vehicle is a registered or “safe” vehicle, whether each vehicle is a non-registered or “unknown” vehicle, the make, model, and/or color of each vehicle, and the like. This way, the report transmitted to law enforcement officers will better enable the law enforcement officers to narrow down potential suspects based on any additional evidence (e.g., witness observations of a red car), whether the perpetrator likely was not from the community (i.e., the perpetrator likely entered the community in a vehicle that is not registered), and the like. Of course, the system may record historical data of the vehicles that enter and exit a community, and this historical record can be provided to law enforcement entities or other interested third parties when the information would be helpful.

Such plate tracking technology may be especially helpful in campuses, neighborhoods, or other communities with defined geographic areas that are susceptible to unregulated (or slightly regulated) traffic, as the system will be able to acquire, identify, and report important information about the vehicles that are present in the community at any given point in time.

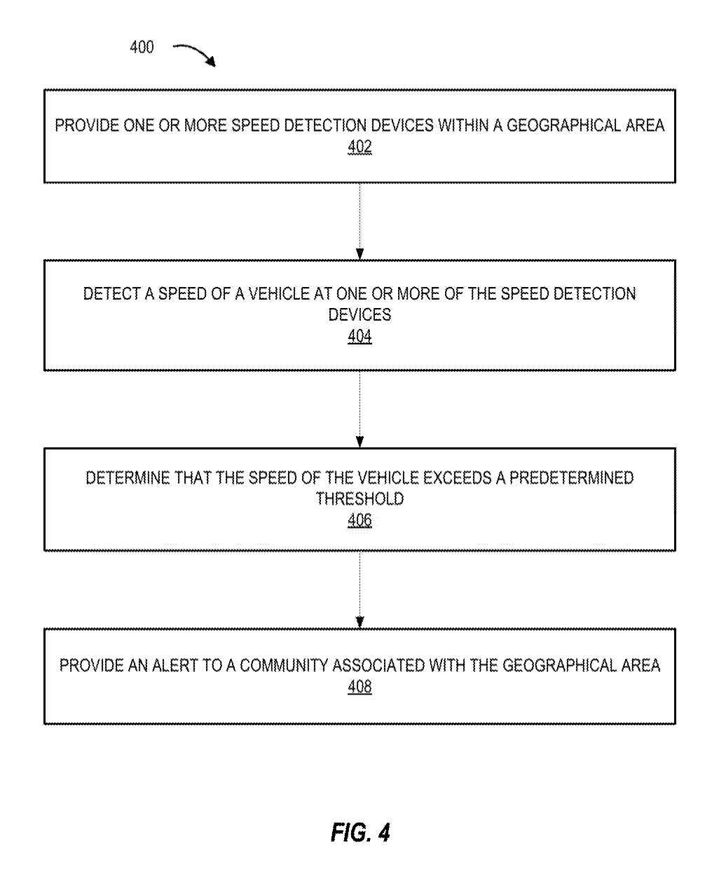

Referring now to FIG. 4, a flowchart is provided to illustrate a process 400 for providing a speed enforcement community security system, in accordance with an embodiment of the invention. By incorporating other elements of a community security system in real time, this speed enforcement system can alert appropriate members of the community, security personnel, and/or police personnel to the presence of a speeding vehicle quickly enough that the speeding vehicle can be apprehended or discouraged very quickly after the speeding incident is recorded. This is a substantial improvement to conventional speed traps that merely record the occurrence of a speeding vehicle and vehicle information such that a speeding ticket may be sent to the expected perpetrator in the mail.

The process 400 shown in FIG. 4 may include block 402, where the system provides one or more speed detection devices within a geographical area. These speed detection devices may be cameras, automatic radar guns and detectors, pressure hoses, laser emitters and detectors, and the like, or any combination of the above. The speed detection devices may be triggered by a motion sensor. Additionally or alternatively, the speed detection devices may be actively on at all times, or during designated times, such that they record differences from the normal detection response when a vehicle passes by.

In some embodiments, a single speed detection device is used to monitor passing vehicles. For example, a radar emitter and detector may be used in conjunction with a motion detection device. The motion detection device may trigger the radar emitter to transmit radar signals, which return off of the moving vehicle, and are received at the radar detector, which can convert the return signal into a speed of the vehicle.

In other embodiments, multiple speed detection devices may be used to monitor the speed of passing vehicles. For example, a first pressure hose may be positioned at a first location across a road in the geographical area of the community. A second pressure hose may be positioned across a road at a second location that is a known distance away from the first pressure hose. The pressure hoses may be positioned in areas where it is likely that a single vehicle will cross both pressure hoses before a second vehicle interacts with the second hose. Each pressure hose may be operatively coupled to a pressure receiver that can record a timestamp for each time the pressure hose transmits a large pressure change (e.g., when a vehicle passes over the pressure hose). In such embodiments, the system may receive, in real time, a first time stamp for when a vehicle passes over the first pressure hose, and a second time stamp for when a vehicle passes over the second pressure hose. The system may then divide the distance between the two hoses by the difference in the two time stamps to determine the average speed of the vehicle across that distance. The same concept could be used for two cameras that record time stamps with recorded images of a moving vehicle.

The process 400 may also include block 404, where the system detects a speed of a vehicle at one or more of the speed detection devices. As mentioned above, the speed detection devices may record the speed of vehicles as the vehicles pass by, and the speed detection devices may automatically transmit the detected speed in real time to other components of the system. In this example embodiment of process 400, a single vehicle has passed by one or more of the speed detection devices, and the speed detection device(s) has detected the speed and stored the recorded speed for the vehicle in a database.

In some embodiments, the process 400 includes block 406, where the system determines that the speed of the vehicle exceeds a predetermined threshold. The system may access the speed detection device to analyze the detected speed information for the vehicle, or the speed detection device may have automatically transmitted the detected speed of the vehicle to a speed analyzing application of the system. They system may compare this received speed of the vehicle with a stored, predetermined threshold speed for the location or region of the speed detection device(s). In some embodiments, the system determines that this recorded speed exceeds the predetermined threshold speed. In some embodiments, the predetermined threshold speed is a constant speed that is associated with, or is equal to a speed limit for the area. In some embodiments, the predetermined threshold speed may change based on the time of day, the day of the week, and the weather to adjust what is considered excessive for the region. For example, the predetermined threshold speed may normally be five miles an hour over a posted speed limit, but this threshold is lowered to the exact posted speed limit after sunset, on holidays, during the summer, while it is raining, while it is snowing, or while it is foggy.

As such, the system can adjust its settings for the predetermined threshold based on the desires of a community. As excessive speed in conjunction with bad weather can produce a bad result, weather can be a good indicator of what an excessive speed should be. Additionally, many communities have children that play in yards, and therefore the community may tolerate a lower threshold speed during the summer, holidays, weekends, and at times when children are expected to be home from school. If the speed detection devices are set up at a school, then the threshold may be adjusted during times when children are at the school. Additionally, the speed detection devices may have one or more motion sensing devices that can detect when an object is moving along a sidewalk or land adjacent to a road. While this motion sensor detects these adjacent objects, the system may lower the threshold speed as it may assume that pedestrians are nearby.

In response to determining that the speed of the vehicle exceeds the predetermined threshold, the process 400 may include block 408, where the system provides an alert to a community associated with the geographical area. The community may be any group of individuals that has an interest in the safety of the road in which the speed detecting device recorded a speeding vehicle. For example, the community may be a neighborhood, an office complex, a university, a school, a vacation neighborhood, a resort, a town, and the like.

The alert may be transmitted to at least a portion of the community electronically to a computing device of individual members (e.g., text message, phone call, email, pop-up notification, or the like), audibly by an alert tower (e.g., siren, spoken warning, and the like), visibly by an alert tower (e.g., flashing lights, bright lights, flood lights, a light-based messaging board, and the like), or any combination of the above. The alert tower may be the same or substantially the same device as the speed monitoring device, it may be a device located down the road (in the direction of travel for the speeding vehicle), or in any other position in the geographical area associated with the community. For example, the alert tower may be positioned in a central location of a neighborhood community such that an audible alert may alert the entire neighborhood. In some embodiments, multiple alert towers may be utilized to transmit one or more alerts to the community.

The alert may also be an alert to security personnel of the community, such as a security guard, gate monitor, or the like, to request an intervention with the speeding vehicle. Additionally, the alert may be an alert to a nearby police precinct to alert the precinct of the presence of a currently speeding vehicle.

In some embodiments, the alert is simply transmitted to a speeding database for periodic review by the system and/or a member of the community. This speeding database may be analyzed to provide statistical reports and/or determine patterns in which vehicles are commonly exceeding the threshold speed. This information can be transmitted to the members of the community and/or individuals known to be associated with a commonly speeding vehicle such that the problem can be addressed within the community.

In some embodiments, multiple thresholds may be predetermined, with varying degrees of alerts associated with each threshold. For example, a first predetermined threshold may normally be based on five miles an hour above the speed limit. This first predetermined threshold may only be associated with recording vehicle information (see processes 200 and 300) of the speeding vehicle in the speeding database. Additionally, a second predetermined threshold may be established at fifteen miles an hour above the posted speed limit. This second predetermined threshold may trigger an alert from an alert tower to warn the community of the presence of a speeding vehicle in the area. Any combination of speed thresholds and alerts can be used to provide a desired level of safety and notification to the community.

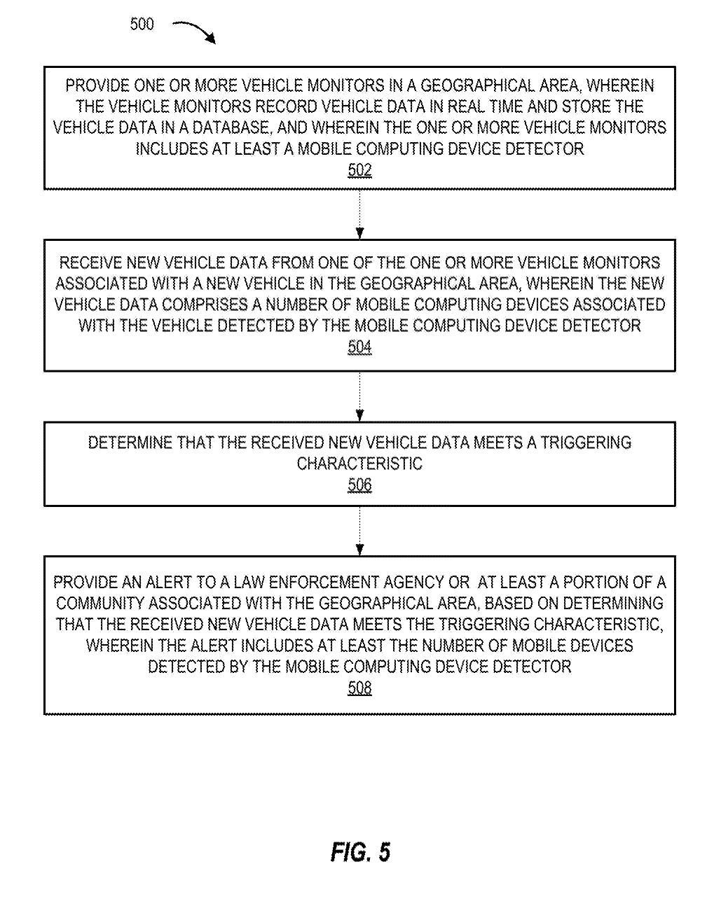

FIG. 5 illustrates a process 500 for providing a mobile device recognition community security system, in accordance with an embodiment of the invention. Generally, the process 500 monitors an area of a road in a geographical area of a community for mobile device identification information, records this information as a number of mobile devices associated with a passing vehicle (along with vehicle information), and, in the event of a triggering event, transmits the number of mobile devices associated with the vehicle to an appropriate responder. As most people have a mobile computing device that is detectable, this process 500 can give a responder a good estimate as to how many individuals were in a vehicle at the time of detection. In this manner, the process 500 allows a responder to have a good estimate as to how many individuals may be remaining in a neighborhood (or other community), or were involved in some triggering incident in the neighborhood.

The process 500 may include block 502, where the system provides one or more vehicle monitors in a geographical area, wherein the vehicle monitors record vehicle data in real time and store the vehicle data in a database, and wherein the one or more vehicle monitors includes at least a mobile computing device detector. The vehicle monitors may be any vehicle monitor as described in relation to process 200 of FIG. 2. Additionally, the vehicle monitors comprise one or more mobile computing device detectors that scan for, and detect, mobile device signatures, media access control (“MAC”) addresses, and the like of mobile computing devices that likely are within the passing vehicle. These mobile computing device detectors scan, or ping, an area where vehicles are expected to travel at the same point as the rest of the vehicle monitoring device, or in a point substantially adjacent thereto. The mobile computing device detectors can be triggered to scan and/or record identified MAC addresses and/or mobile signatures at the same time the rest of the vehicle monitoring device records vehicle information data of a passing vehicle.

The process 500 may also include block 504, wherein the system receives new vehicle data from one of the one or more vehicle monitors associated with a new vehicle in the geographical area, wherein the new vehicle data comprises a number of mobile computing devices associated with the new vehicle, as detected by the mobile computing device detector. As described with respect to process 200 of FIG. 2, the system receives relevant data associated with a new vehicle as the vehicle passes by. In addition, the system receives MAC address and/or mobile signature information for one or more mobile computing devices that were recorded during a substantially similar time interval as the new vehicle data was acquired. In some embodiments, the actual MAC addresses and/or mobile signatures are recorded. In other embodiments, the system only records the number of unique MAC addresses and/or mobile signatures. This mobile computing device information is then stored as a number of identified mobile computing devices associated with the new vehicle. This number of identified mobile computing devices can be assumed to be an estimate of the number of occupants of the new vehicle, as most individuals have one mobile communication device (e.g., mobile phone, smart phone, smart watch or other wearable, tablet, and the like) that is normally turned on.

In some embodiments, the process 500 includes block 506, where the system determines that the received new vehicle data meets a triggering characteristic. The triggering characteristics are described above with respect to process 200 of FIG. 2. In some embodiments where a MAC address can be identified by the system, and not just detected, the system may compare the identified MAC address with stored registered or authorized MAC addresses to determine whether the identified MAC address is associated with a registered mobile computing device or not. In some embodiments, the system may determine that the identified MAC address matches with a stored unauthorized MAC address, and therefore may determine that a triggering event has occurred based on the identification of the MAC address of a mobile device in the new vehicle.

Finally, the process 500 may include block 508, where the system provides an alert to a law enforcement agency or at least a portion of a community associated with the geographical area, based on determining that the alert meets the triggering characteristic, wherein the alert includes at least the number of mobile computing devices detected by the mobile computing device detector. The alert may also comprise a footnote or other indication that the number of computing devices is a good indication of the number of individuals expected to be in the new vehicle that triggered the alert.

In some embodiments, the alert may simply comprise a command to store the information related to the number of mobile computing devices in a database that can be referred to later in the event the new vehicle is identified as having taken part in unlawful or otherwise unwanted actions within the geographical area of the community. For example, the system may store the number of detected mobile computing devices in a database when the new vehicle is determined to not be a registered vehicle. Later, a police office and/or a member of the community may determine that one or more of the occupants of the new vehicle were involved in a break-in, hit-and-run, or other nefarious incident within the community. The system may then provide the number of detected mobile devices to the police officer and/or the member of the community such that an investigation can have a better understanding of how many people likely were involved in the incident.

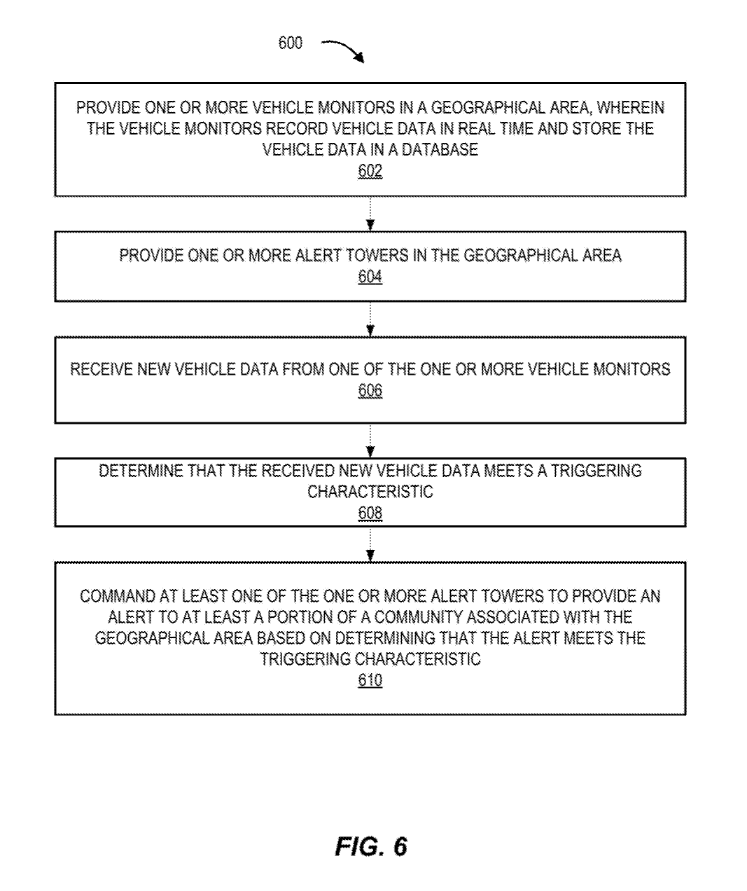

Referring now to FIG. 6, a flowchart is provided to illustrate a process 600 for providing an alert tower community security system, in accordance with an embodiment of the invention. Generally, the process 600 provides one or more alert towers in a geographical area of a community, where the alert towers are configured to receive alert information and relay the alert to at least a portion of the community. The process 600 may include block 602, where the system provides one or more vehicle monitors in a geographical area, wherein the vehicle monitors record vehicle data in real time and store the vehicle data in a database. These vehicle monitors may be the same, or substantially similar to the vehicle monitors described with regard to the processes 200 and 500.

In some embodiments, the process 600 includes block 604, where the system provides one or more alert towers in the geographical area. An alert tower may be any device within the geographical area of a community that can receive (or detect) alert information and transmit the alert to members of the community. In some embodiments an alert tower is an actual tower with speakers, lights, and/or antennas for communicating alert information. In other embodiments, the alert towers are simply devices located on or adjacent to houses, buildings, poles, and the like within a community, with speakers, lights, and/or antennas for communicating alert information. In some embodiments, an alert tower is connected to a community safety system network by an electronic cable that can transmit information to, and/or receive information from, the alert tower. In some embodiments, a single alert tower is provided within the geographical area of the community. In other embodiments, multiple alert towers are provided within the geographical area of the community.

The process 600 may also include block 606, where the system receives new vehicle data from one of the one or more vehicle monitors. As described with regard to the processes 200 and 500, the new vehicle data comprises detected information about a vehicle that is currently present in the geographical area. The system may receive this new vehicle data in real time, as the vehicle monitors detect the presence of the vehicle.

Additionally, the process 600 may include block 608, where the system determines that the received new vehicle data meets a triggering characteristic. As described with regard to the processes 200 and 500, the system may compare the received new vehicle data to registered vehicle data in a registered vehicle database to determine whether or not the new vehicle data matches registered vehicle data. In some embodiments, if the identified new vehicle data does not match the registered vehicle data, then the system determines that the received new vehicle data meets a triggering characteristic, triggering an alarm associated with the triggering characteristic.

Finally, in some embodiments, the process 600 may include block 610, where the system commands at least one of the one or more alert towers to provide an alert to at least a portion of a community associated with the geographical area, based on determining that the alert meets the triggering characteristic.

In some embodiments, the system sends a command to one or more alert towers to emit an audible alarm from one or more speakers of each alert tower. The audible alarm may be a siren, a pre-recorded spoken warning, or a combination of a prerecorded spoken warning and a description of the triggered alert (e.g., description of the new vehicle, instructions to members of the community on how to be protected from the incident causing the alert, and the like).

Additionally, or alternatively, the system may send a command to the one or more alert towers to emit a lighted warning to members of the community and/or individuals associated with the identified new vehicle. Examples of a lighted warning include flashing lights, bright lights, flood lights, a lighted message board, search beams, and the like. In some embodiments, the lighted warning serves as a deterrence for individuals associated with the identified new vehicle. For example, the system may command an alert tower to turn on flood lights that brightly illuminate an area that may be vandalized or otherwise tampered with. The flood light may deter individuals from approaching the area as they could be easily spotted. Similarly, flashing lights or a lighted message board may alert an individual associated with the new vehicle that the community has determined that the vehicle is not a registered vehicle, and that appropriate responders may have been identified to confront the occupants of the identified new vehicle.

In some embodiments, the system may send a command to the one or more alert towers to transmit an electronic message (e.g., a text message, an email, an automated phone call, a pop-up notification, and the like) to at least a portion of the community, based on the determination that the new vehicle caused a triggering event. For example, the system may determine that an unauthorized vehicle has entered the geographical area of the community, and therefore members of the community should be notified to be on the lookout for a vehicle of a matching description, and to be cautious regarding its occupants.

In some embodiments, an alert tower may additionally comprise an emergency button that may be selected by a person in need of emergency assistance. In response to the button being pressed, the system may command the alert tower to send an alert to at least a portion of the community, security personnel, and/or police personnel. For example, if an individual presses the emergency button of an alert tower, the alert tower may turn on flood lights around the alert tower, emit an additional, highly visible flashing light, emit an audible warning to any other individuals in the area around the alert tower, emit an audible request for someone to respond (e.g., anyone that can hear the request, security personnel, police personnel, and the like), and/or transmit an electronic message to members of the community or other potential responders.

Similarly, the system may command the alert towers to transmit messages regarding active shooters, amber alerts, severe weather, dangerous wildlife, and the like. In some embodiments, one or more members of the community may transmit a text or audio message from a computing device of the member to an alert tower regarding a warning, and the alert tower may act as a public address system to transmit the alert to other members of the community.

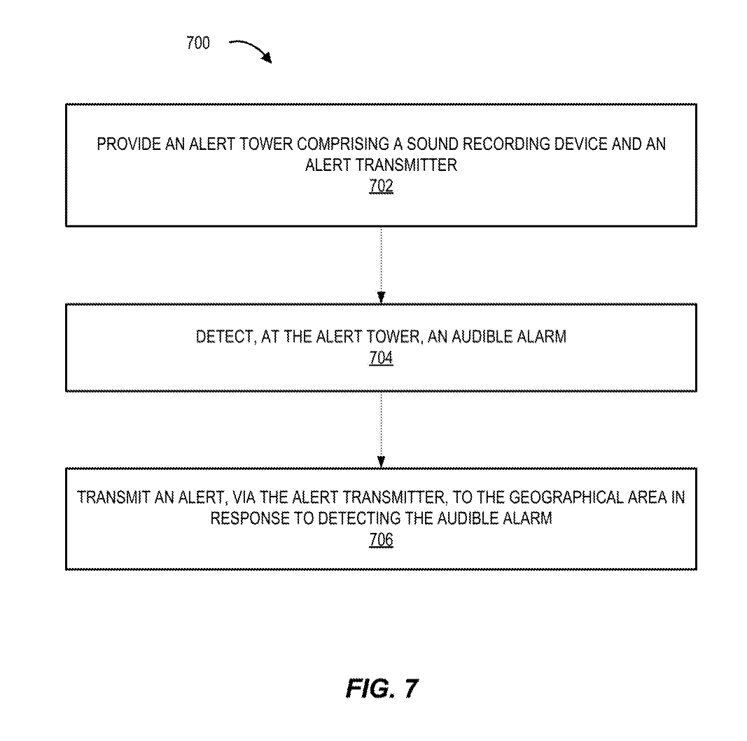

FIG. 7 illustrates a flowchart of a process 700 for providing an alert tower community security system, in accordance with an embodiment of the invention. This process 700 provides a benefit of increased warning, deterrence, and response time to a detected alarm in the geographical area of the community. The process 700 may include block 702, where the system provides an alert tower comprising a sound recording device and an alert transmitter. Of course, as described with respect to the process 600, the system may include multiple alert towers throughout the geographical area of the community. The alert towers are configured to detect audible alarms from houses, cars, buildings, emergency vehicles, and the like, while filtering out other loud noises such as slamming doors, loud engines, loud music, thunder, and the like.

In some embodiments, the process 700 includes block 704, where the system detects, at the alert tower, an audible alarm. In some embodiments, the alert tower may access a database of known audible alarm sounds. For example, the system may store the sounds of house alarms and car alarms in a database that is accessible by an alert tower. The alert tower may then detect an audible alarm, and compare the detected alarm to the database to determine that the detected alarm matches at least one of the stored alarms in the database. In some embodiments the alert tower may monitor detected noises for sustained noises within a predetermined decibel and/or frequency range that is normally associated with car and/or house alarms. When the alert tower detects a sustained noise within this predetermined range, then the system may determine that the alert tower has detected an audible alarm. Additionally, the alert tower may monitor an area for signals that exceed a certain decibel level.

While some embodiments of the invention describe the signal as being monitored and detected by the alert tower as an audible signal, any detectable signal may be used. For example, in some embodiments, a house or car alarm may be programmed to emit a supersonic, radio, or infrared signal that is inaudible or invisible to people, but is detectable by one or more alert towers.

The process 700 may also include block 706, where the system transmits an alert, via the alert transmitter, to the geographical area in response to detecting the audible alarm. As described in more detail with regard to the process 600, the system may transmit audible, visual (e.g., light), or electronic alarms or messages to at least a portion of the community and/or potential responders such as security personnel or police personnel.

In some embodiments, the system may command the alert tower to transmit a message indicating that a break-in likely is happening in the community and warning members of the community to protect themselves and/or assist in determining whether a threat exists.

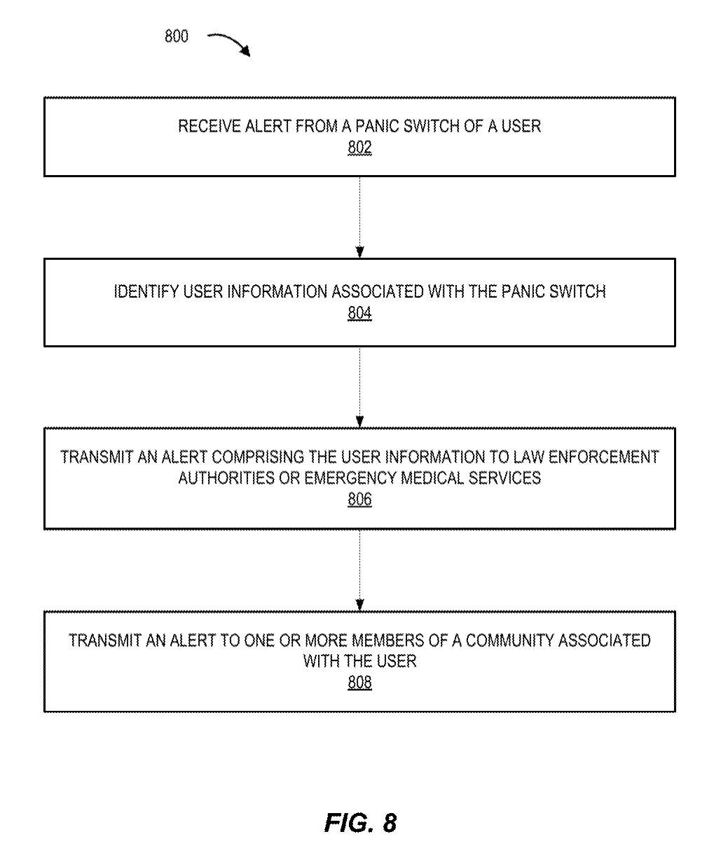

With respect to FIG. 8, a flowchart of a process 800 for receiving and communicating community alerts is provided. The process 800 described herein is useful for providing health and/or security assistance to users of a community in a timely manner while additionally providing valuable information to other members of the community. The process 800 may include block 802, where the system receives an alert from a panic switch of a user. As used herein, the user may be any individual that is part of a community supported by the overall system. For example, the user may be a student at a university that provides this communication alert system.

In some cases, the “panic switch” described herein may be a physical button, switch, knob, toggle, or other physical device capable of changing its state or orientation to transmit a signal. For example, the panic switch may be a button on a device configured to be worn around a user's neck. The user may press the button to indicate the occurrence of a health or security issue of the user or someone nearby. By pressing the button, the device may transmit an alert over a wireless communication network to an integrated management security system server. In other cases, the “panic switch” described herein may be an electronic button, switch, etc., that can be presented on a user interface display of a computing device. For example, the panic switch may comprise a virtual representation of a button on a display of a mobile device of a user. In such embodiments, the panic switch may be associated with an application stored within the mobile device of the user.

An integrated management security system may provide multiple panic switches to members of a community (e.g., a school, a neighborhood, an apartment complex, etc.). These panic switches may be pre-programmed to automatically transmit a general alert signal in response to being pressed by the user. Additionally, the panic switches may comprise multiple buttons, switches, etc., that can each be pushed to indicate a specific type of health and/or security issue. For example, a single panic switch may comprise four buttons labelled as “fire,” “intruder,” “health,” and “other,” respectively. Of course, other labels are possible, and these are provided only for illustrative purposes. In some embodiments, the panic switch allows a user to type and/or record at least a short message describing the current issue. For example, in response to the panic switch being held down, the system may cause the panic switch to begin recording audio. This audio can be transmitted to the integrated management security system once the panic switch is released. In other embodiments, in response to the panic switch being pressed, the system may open a telecommunication (or other wireless communication) link between the pressed panic switch and a support person associated with the integrated management security system.

Once the integrated management security system receives the alert from the panic switch, the system may identify user information associated with the panic switch as stated in block 804. The user information may include a specific health or security issue associated with the alert, identification information of the user (e.g., name, age, any known medical conditions, family member information, home address information, work address information, contact information, and the like), and GPS or other location-based information. The user information may be especially helpful in responding to the health or security issue that the user is experiencing, as it may help a responder to know the current location of the user, health sensitivities of the user, contact information of the user and people associated with the user, and the like.

In some embodiments, the integrated management security system may house or be operatively connected to a database of stored user information that is tagged or otherwise searchable by an identifier of a specific panic switch that is associated with that user. In this way, once the system receives the alert (including the panic switch identifier) from the specific panic switch, the system can compare the identifier of the panic switch to the user information already stored in its database to identify the associated user information.

Next, the system may proceed to block 806, where the system transmits an alert comprising the user information to law enforcement authorities and/or emergency medical services. In embodiments where the user is able to convey the nature of the user's issue (e.g., through a dedicated button on the panic switch, through a message or communication with the integrated management security system, etc.), the system may determine which specific entity or agency to contact to address the user's issue and therefore will only transmit an alert to that entity or agency.

The transmitted alert may comprise an automated message (e.g., text message, email, specialized online forum message, and the like) that alerts a potential responder of the user's issue, as well as to provide a data packet of any important user information. For example, the alert transmitted to an emergency medical services group may comprise a GPS location of the user (note that this GPS location may be updated periodically or in real time to provide real time information of the user's location), the user's name, age, and any medical conditions that an emergency medical services provider would benefit from knowing. Additionally or alternatively, the alert transmitted to a law enforcement agency may comprise the GPS location of the user, the user's name, the nature of a security risk communicated by the user via the panic switch, and any other information that the law enforcement agency may benefit from knowing.

While informing medical entities and law enforcement agencies can be very beneficial to aiding the user in overcoming the user's current medical or security issues, the integrated management security system can further protect and inform other members of the community associated with the user by transmitting an alert to one or more members of the community, as laid out in block 808.

As described throughout this application, the community members may be notified by the alert through several different means. For example, an alert may be transmitted to mobile devices of the users in the form of a pop-up notification, a text message, a video message, an audible alarm from speakers on the mobile devices, any combination of the above, and the like. Additionally or alternatively, the members of the community may be notified through one or more alerts emitted from the alert tower system set up throughout the geographic area of the community, and/or from audible, visual or other alerts from security systems internal to the members' homes or other buildings and operatively connected to the integrated management security system to exchange communications.

The alerts transmitted to the community members may comprise an indication that a security or health issue has occurred or is currently occurring within the community, a location of the security or health issue, instructions on how to address the issue(s), and the like. In embodiments where the integrated management security system has determined which threat is present, the system can target the community alerts to those in the community that likely are or will be affected by the threat. For example, if the issue comprises a fire at a certain location in the community, then the community alert may go out to all members of the community within a predetermined distance from the location of the fire, that are expected to be near the location of the fire, that are associated with the user and/or other members of the community that likely are affected by the fire, and the like. In some embodiments, only the tower(s) closest to the location that the panic switch was pressed is used to emit the community alert.

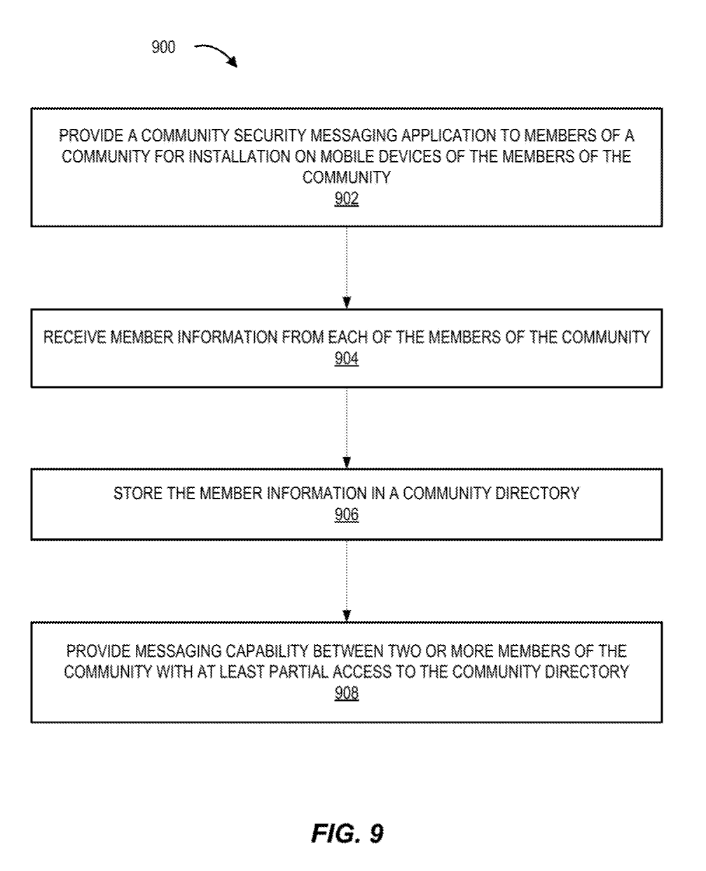

FIG. 9 provides a flowchart describing a process 900 for providing a community security messaging system to multiple members of a community. In some embodiments, the process 900 includes block 902, where the system provides a community security messaging application to members of a community for installation on mobile devices of the community. In other embodiments, alternatively or additionally, members may have home or building security systems that are operatively connected with the integrated management security system for exchanging communications. In such embodiments, the home security system(s) may run an application similar to the mobile device application that includes an interface for messaging and input of information from the members. Again, the community may be any organization of individuals with some commonality that a community security messaging system can benefit. For example, the system may provide the community security messaging application to students of a university, residents of a neighborhood or apartment complex, employees of a company that work in a plant or other large office space, and the like. These community members may then download the applications onto their personal and/or business mobile devices to be prepared to utilize the community security messaging application system.

Once the community members have received and/or installed the community security messaging application, the system may prompt the individual community members to provide certain information (“member information”) that can be transmitted back to the managing system. The process 900 may then proceed to block 904, where the system receives the member information from each member (or at least some members) of the community. The member information may be any information associated with the member including, but not limited to, name, address, office location, schedule, username, family information (e.g., other members in the family, contact information for these other family members, ages and sexes of the other family members, etc.), pet information, car information (e.g., make, model, year, color, license plate number, etc.), contact information, and the like.

As shown in block 906, the system may then store the member information in a community directory or other database. In some embodiments, this community directory is a secured database that is not accessible by regular members of the community, but may be accessed by one or more security management specialists associated with the community. For example, in an emergency, the security management specialist(s) may be able to access this information and provide this information to the appropriate responders and/or members of the community to address the emergency. In other embodiments, at least a portion of the member information in the community directory is made available to other members of the community. For example, very generic family information (number in family, address of house, approximate age and sex of each member, pet information, etc.) may be provided. Additionally or alternatively, more detailed information may be provided (e.g., names, car information, contact information, etc.). This community directory may be searchable by the members of the community to help foster a sense of community among the community members as well as to provide a source for finding beneficial information about neighbors or coworkers for security and/or health reasons.

Finally, as shown in block 908, the system may provide messaging capability between two or more of members of the community with at least partial access to the community directory. In some embodiments, the messaging communication is done without transmitting personally identifiable information. For example, the messaging platform may be a forum with anonymous posters, or may have numeric codes to identify users that are not related to information associated with a user. In this way, the system can provide a safe, secure forum for members of the community to present concerns, issues, worries, recommendations, and the like without fear of being targeted or called out as an individual member of the community. Of course, the messaging platform may also or alternatively allow for communication with limited personally identifiable information (e.g., based on an address or geographical location of the user, a username, just a first name, and the like).

The community security messaging application may provide a forum or group-chat system where the members of the community are able to post comments, responses, questions, recommendations, community meeting information, and the like. Additionally or alternatively, the community security messaging application may allow members to communicate directly with each other. In such embodiments, one member may be able to search for a known user or username to provide a community-based message. In other such embodiments, an alerting member may be able to transmit a community-based message to one or more other members of the community based on member information, even if the alerting member does not know which member(s) the message will go to. For example, an alerting member may notice that a garage door of one house is open in the middle of the day without any cars around. The alerting member may then search the community database to identify and transmit a warning message to the one or more members of the community that are associated with the address of the house with the open garage door. Similarly, the alerting member may transmit a warning message based on a GPS location of the alerting member at the time of the message. In this way, the system will transmit the warning message to all members with addresses located within a predetermined distance from the GPS location.

In another embodiment, an alerting member may identify a lost dog and can search the database for a member that has the same dog. Alternatively, the alerting member can transmit a warning message to all members in the community that own a dog by filtering the community members to only include dog owners.

Additionally, if an alerting user notices that a teenage boy is injured in a yard in the community's neighborhood, the alerting user can search the community database to identify which members of the community may be in the same family as the teenage boy. For example, the user may check the member information associated with nearby houses, may filter the community database to only show members with teenage boys, and the like.

In some embodiments, the alerting member can transmit a warning message to a central monitoring center that may include one or more supervisors or community response specialists. The supervisors and/or community response specialists may then vet the warning message to make sure it is appropriate, to identify a member of the community that should receive the warning message, contact emergency medical services, contact a law enforcement agency, and the like. Of course, the system may allow an alerting member to transmit one or more images, video recordings, audio recordings, and the like.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with providing a community security system.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for providing alerts to a community regarding security, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for community security monitoring, the system comprising:
one or more security devices;
one or more memory devices having computer readable program code stored thereon;
a communication device; and
one or more processing devices operatively coupled to the one or more memory devices, wherein the one or more processing devices are configured to execute the computer readable program code to:
monitor the one or more security devices for a triggering characteristic;
receive the triggering characteristic from at least one of the one or more security devices;
in response to receiving the triggering characteristic, provide an alert to one or more members of a community or to one or more security responders.

2. The system of claim 1, wherein the system further comprises:
the one or more security devices comprise vehicle monitors positioned in a geographical area, and wherein the vehicle monitors are configured to:
record vehicle data in real time; and
store the vehicle data in a database; and
wherein the one or more processing devices are further configured to execute the computer readable computer program code to:
receive new vehicle data from one of the vehicle monitors, wherein the new vehicle data comprises vehicle data associated with a new vehicle in the geographical area;
determine that the received new vehicle data meets the triggering characteristic; and
provide the alert to the one or more members of the community or to the one or more security responders based on determining that the received new vehicle data meets the triggering characteristic, wherein the one or more members of the community are associated with the geographical area.

3. The system of claim 2, wherein the system further comprises:
the one or more security devices comprising the vehicle monitors, wherein the vehicle monitors include one or more cameras configured to record, in real time, an image or video of vehicles as the vehicles pass by; and
wherein the one or more processing devices are further configured to execute the computer readable computer program code to:
receive registered vehicle information from the one or more members of the community;
store the registered vehicle information in a registered vehicle database;
receive the new vehicle data, wherein the new vehicle data includes a new image or video of the new vehicle received from the one or more cameras;
analyze the new image or video to identify new vehicle information;
compare the identified new vehicle information to the stored registered vehicle information; and
take no action in response to determining that the new vehicle information matches at least a portion of registered vehicle information; or
provide the alert to the one or more members of the community or to the security responders in response to determining that the new vehicle information does not match any of the registered vehicle information.

4. The system of claim 2, wherein the system further comprises:
the one or more security devices comprising the vehicle monitors, wherein the vehicle monitors include vehicle speed detection devices; and
wherein the one or more processing devices are further configured to execute the computer readable computer program code to:
receive the new vehicle data, wherein the new vehicle data comprises a detected speed of the new vehicle at one or more of the speed detection devices;
compare the detected speed of the new vehicle to a predetermined speed threshold associated with the geographical location;
determine, based on the comparison of the detected speed to the predetermined speed threshold, that the detected speed of the new vehicle exceeds the predetermined speed threshold; and
in response to determining that the detected speed of the new vehicle exceeds the predetermined speed threshold, provide the alert to the one or more members of the community or to the one or more security responders.

5. The system of claim 2, wherein the system further comprises:
the one or more security devices comprising the vehicle monitors, wherein the vehicle monitors include at least a mobile computing device detector; and
wherein the one or more processing devices are further configured to execute the computer readable computer program code to:
receive the new vehicle data, wherein the new vehicle data comprises a number of mobile computing devices associated with the new vehicle detected by the mobile computing device detector; and
in response to determining that the received new vehicle data meets the triggering characteristic, provide the alert to the one or more members of the community or to the security responders, wherein the alert includes at least the number of mobile devices associated with the new vehicle.

6. The system of claim 2, wherein the system further comprises:
one or more alert towers positioned in the geographical area; and
wherein the one or more processing devices are further configured to execute the computer readable program code to:
command at least one of the one or more alert towers to provide the alert to the one or more members of the community based on determining that the received new vehicle data meets the triggering characteristic.

7. The system of claim 6, wherein commanding the at least one of the one or more alert towers to provide the alert further comprises causing one or more speakers of the one or more alert towers to emit an audible alarm.

8. The system of claim 1, wherein the system further comprises:
one or more alert towers positioned in a geographical area, wherein the one or more alert towers comprise an audio detecting device and an alert transmitter; and
wherein the one or more processing devices are further configured to execute the computer readable program code to:
receive the triggering characteristic from the at least one or more security devices by detecting, via the audio detecting device of the one or more alert towers, an audible alarm; and
in response to detecting the audible alarm, provide the alert to the one or more members of the community via the alert transmitter of the one or more alert towers.

9. A method for community security monitoring, the method comprising:
monitoring one or more security devices for a triggering characteristic;
receiving the triggering characteristic from at least one of one or more security devices;
in response to receiving the triggering characteristic, providing an alert to one or more members of a community or to one or more security responders.

10. The method of claim 9, wherein the method further comprises:
receiving new vehicle data from vehicle monitors, wherein the new vehicle data comprises vehicle data associated with a new vehicle in a geographical area;
determining that the received new vehicle data meets the triggering characteristic; and
providing the alert to the one or more members of the community or to the one or more security responders based on determining that the received new vehicle data meets the triggering characteristic, wherein the one or more members of the community are associated with the geographical area.

11. The method of claim 10, wherein the method further comprises:
receiving registered vehicle information from the one or more members of the community;
storing the registered vehicle information in a registered vehicle database;
receiving the new vehicle data, wherein the new vehicle data includes a new image or video of the new vehicle received from the one or more cameras;
analyzing the new image or video to identify new vehicle information;
comparing the identified new vehicle information to the stored registered vehicle information; and
taking no action in response to determining that the new vehicle information matches at least a portion of registered vehicle information; or
providing the alert to the one or more members of the community or to the security responders in response to determining that the new vehicle information does not match any of the registered vehicle information.

12. The method of claim 10, wherein the method further comprises:
receiving the new vehicle data, wherein the new vehicle data comprises a detected speed of the new vehicle at one or more speed detection devices;
comparing the detected speed of the new vehicle to a predetermined speed threshold associated with the geographical location;
determining, based on the comparison of the detected speed to the predetermined speed threshold, that the detected speed of the new vehicle exceeds the predetermined speed threshold; and
in response to determining that the detected speed of the new vehicle exceeds the predetermined speed threshold, providing the alert to the one or more members of the community or to the one or more security responders.

13. The method of claim 10, wherein the method further comprises:
receiving the new vehicle data, wherein the new vehicle data comprises a number of mobile computing devices associated with the new vehicle detected by a mobile computing device detector; and
in response to determining that the received new vehicle data meets the triggering characteristic, providing the alert to the one or more members of the community or to the security responders, wherein the alert includes at least the number of mobile devices associated with the new vehicle.

14. The method of claim 10, wherein the method further comprises:
commanding at least alert tower to provide the alert to the one or more members of the community by emitting an audible alarm based on determining that the received new vehicle data meets the triggering characteristic.

15. The method of claim 9, wherein the method further comprises:
receiving the triggering characteristic from the at least one or more security devices by detecting, via an audio detecting device of one or more alert towers, an audible alarm; and
in response to detecting the audible alarm, providing the alert to the one or more members of the community via an alert transmitter of the one or more alert towers.

16. A computer program product comprising:
a non-transitory computer-readable medium having computer-readable program code portions embodied thereon, the computer-readable program code portions comprising computer readable program code configured to:
monitor one or more security devices for a triggering characteristic;
receive the triggering characteristic from at least one of one or more security devices;
in response to receiving the triggering characteristic, provide an alert to one or more members of a community or to one or more security responders.

17. The computer program product of claim 16, further comprising computer readable program code configured to:
receive new vehicle data from vehicle monitors, wherein the new vehicle data comprises vehicle data associated with a new vehicle in a geographical area;
determine that the received new vehicle data meets the triggering characteristic; and
provide the alert to the one or more members of the community or to the one or more security responders based on determining that the received new vehicle data meets the triggering characteristic, wherein the one or more members of the community are associated with the geographical area.

18. The computer program product code of claim 17, further comprising computer-readable program code configured to:
receive registered vehicle information from the one or more members of the community;
store the registered vehicle information in a registered vehicle database;
receive the new vehicle data, wherein the new vehicle data includes a new image or video of the new vehicle received from the one or more cameras;
analyze the new image or video to identify new vehicle information;
compare the identified new vehicle information to the stored registered vehicle information; and
take no action in response to determining that the new vehicle information matches at least a portion of registered vehicle information; or
provide the alert to the one or more members of the community or to the security responders in response to determining that the new vehicle information does not match any of the registered vehicle information.

19. The computer program product code of claim 17, further comprising computer-readable program code configured to:
receive the new vehicle data, wherein the new vehicle data comprises a detected speed of the new vehicle at one or more speed detection devices;
compare the detected speed of the new vehicle to a predetermined speed threshold associated with the geographical location;
determine, based on the comparison of the detected speed to the predetermined speed threshold, that the detected speed of the new vehicle exceeds the predetermined speed threshold; and
in response to determining that the detected speed of the new vehicle exceeds the predetermined speed threshold, provide the alert to the one or more members of the community or to the one or more security responders.

20. The computer program product code of claim 17, further comprising computer-readable program code configured to:
receive the new vehicle data, wherein the new vehicle data comprises a number of mobile computing devices associated with the new vehicle detected by a mobile computing device detector; and
in response to determining that the received new vehicle data meets the triggering characteristic, provide the alert to the one or more members of the community or to the security responders, wherein the alert includes at least the number of mobile devices associated with the new vehicle.
